(19) United States
(12) Patent Application Publication
(10) Pub. No.: US 2018/0183199 A1
(43) Pub. Date: Jun. 28, 2018

(54) FLEXIBLE MEMBER LINKING METHOD

(71) Applicant: MABUCHI MOTOR CO., LTD., Matsudo City (JP)

(72) Inventor: Kenji OHI, Matsudo City (JP)

(73) Assignee: MABUCHI MOTOR CO., LTD., Matsudo City (JP)

(21) Appl. No.: 15/808,517

(22) Filed: Nov. 9, 2017

(30) Foreign Application Priority Data
Dec. 28, 2016 (JP) 2016-256658

(51) Int. Cl. H01R 43/12; H01R 39/38

(52) U.S. Cl. CPC H01R 43/12; H01R 39/385

(57) ABSTRACT

The present invention provides a method for linking a flexible member that is displaced in a predetermined direction and a fixed member linked with the flexible member. The method includes a flexible member supporting step of sandwiching and supporting the flexible member by a first section of a plate-like link member fixed and held to the fixed member and a second section of the link member opposing the first section; and a joining step of joining at least one of the first section and the second section with the flexible member in a contact area in which the first and the second sections contact the flexible member, at a position spaced apart by a predetermined distance from a vibration transmitted end portion to which vibrations of the flexible member are transmitted.

### BACKGROUND

### 1. Technical Field

The present invention relates to a flexible member linking method, and particularly to a flexible member linking method in a case where a movable member is repeatedly moved at high speed.

### 2. Description of the Related Art

In a brushed motor, a brush mechanism that constitutes sliding contacts has one end fixed to a terminal for electrical feeding from outside the motor, and the other end in contact with the commutator. In this case, the other end may oscillate due to undulations on the commutator or external shaking, for example. Conventionally, brush arms (flexible member) are linked with the electrical feeding terminal by mechanical fixing, such as by crimping.

When the fixing is done by crimping, the arms may become detached by an excess or lack of crimping margin at the crimped portion.

Accordingly, a method has been proposed to fix and link the arms to the terminal by spot welding, instead of the mechanical fixing by crimping and the like (see JP-A-2008-17664, for example).

### SUMMARY

In the brushed motor, a rotor is rotated as electric current is supplied to a coil by having brushes, being biased by the arms (flexible member), slidably contact the commutator. In the brushed motor, due to the rotation of the rotor or external shaking applied to the motor, the arms may be repeatedly moved in a predetermined direction, causing vibrations in the arms. With the flexible member linking method disclosed in JP-A-2008-17664, the vibrations caused by the movement of the flexible member is directly transmitted to the spot welding portion. As a result, the spot welding portion may be repeatedly subjected to loading and break.

The present invention has been made in view of the above problem, and an object of the present invention is to provide a flexible member linking method with which the breaking can be better prevented even when the flexible member is moved in a predetermined direction (which is, in an embodiment of the present invention, the direction indicated by arrow x in FIG. 2) and repeatedly subjected to loading.

In order to solve the problem, according to an aspect of the present invention, there is provided a method for linking a flexible member that is displaced in a predetermined direction, and a fixed member linked with the flexible member. The flexible member linking method includes a flexible member supporting step of sandwiching and supporting the flexible member by a first section of a plate-like link member fixed and held to the fixed member, and a second section of the link member opposed to the first section; and a joining step of joining at least one of the first section and the second section and the flexible member in a contact area in which the first and the second sections contact the flexible member, at a position spaced apart by a predetermined distance from a vibration transmitted end portion to which vibrations from the flexible member are transmitted.

In the flexible member linking method according to an aspect of the present invention, the link member may include a U-shape bent portion bent into U-shape; the first and the second sections may be configured as two opposing surfaces of the U-shape bent portion; the flexible member supporting step may include sandwiching and supporting the flexible member by the first and the second sections; and the joining step may include joining at least one of the first section and the second section of the link member and the flexible member.

In the flexible member linking method according to an aspect of the present invention, the second section may include a projecting portion, and the U-shape bent portion may be configured to be bent into U-shape until the projecting portion contacts the flexible member.

In the flexible member linking method according to an aspect of the present invention, the link member may include a neck portion with a reduced width in a widthwise direction; and the U-shape bent portion may be configured to bend the link member into U-shape with reference to the neck portion.

In order to solve the problem, in the flexible member linking method according to an aspect of the present invention, the link member includes a first link member and a second link member; the flexible member supporting step includes a step of sandwiching and supporting the flexible member by the first section of the first link member and the second section of the second link member opposing the first section; and the joining step includes a step of joining the first and the second sections and the flexible member in a contact area in which the first and the second sections contact the flexible member, at a position spaced apart by a predetermined distance from a vibration transmitted end portion to which vibrations from the flexible member are transmitted.

In order to solve the problem, in the flexible member linking method according to an aspect of the present invention, the second section may be provided with a projecting portion; and the flexible member supporting step may include supporting the flexible member by the first and the second sections of the link member in such a way that the projecting portion contacts the flexible member.

The flexible member linking method of the present invention provides the effect of being able to better prevent the breaking of a flexible member even when the flexible member is moved in a predetermined direction and repeatedly subjected to loading.

### BRIEF DESCRIPTION OF THE DRAWINGS

FIG. 1 is a partial cross sectional view for describing the structure of a motor according to the present invention;

FIG. 2 is a plan view for describing the structure of an embodiment for implementing a linking method according to the present invention;

FIG. 3 is a flowchart for describing the procedure of the linking method according to the embodiment of the present invention;

FIG. 4 shows plan views and side views illustrating a link member before being bent into U-shape;

FIGS. 5A-5C show plan views illustrating a joining process for describing a joining method according to an embodiment of the present invention;

FIG. 6 is a plan view for describing the structure of an embodiment different from FIG. 4 for implementing the linking method according to the present invention; and

FIG. 7 is a plan view for describing the structure of an embodiment different from FIG. 2 for implementing the linking method according to the present invention.

### DESCRIPTION OF THE EMBODIMENTS

A flexible member linking method according to a mode of carrying out the present invention will be described with reference to the drawings.

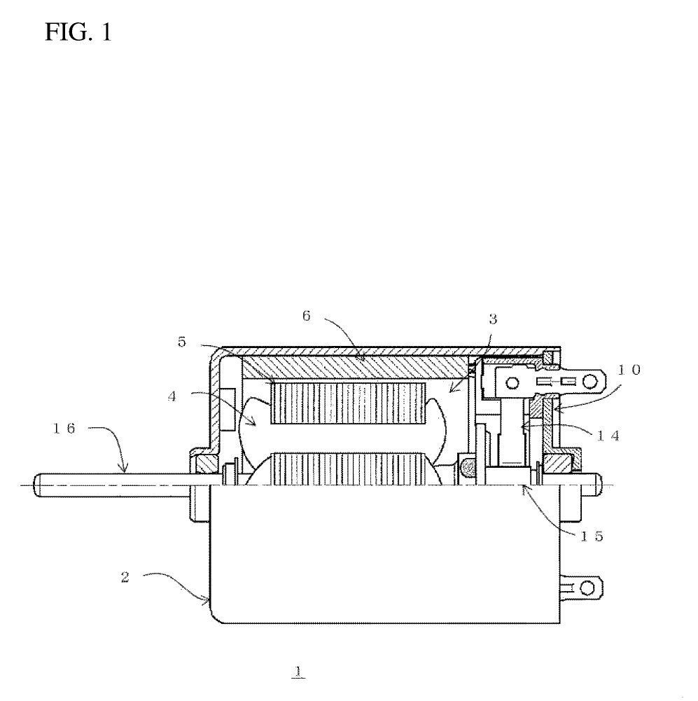

FIG. 1 is a plan view for describing the structure of an embodiment for implementing the linking method according to the present invention. Before describing the linking method of the present invention, a brushed motor as an actuator suitable for implementing the linking method of the present invention will be described.

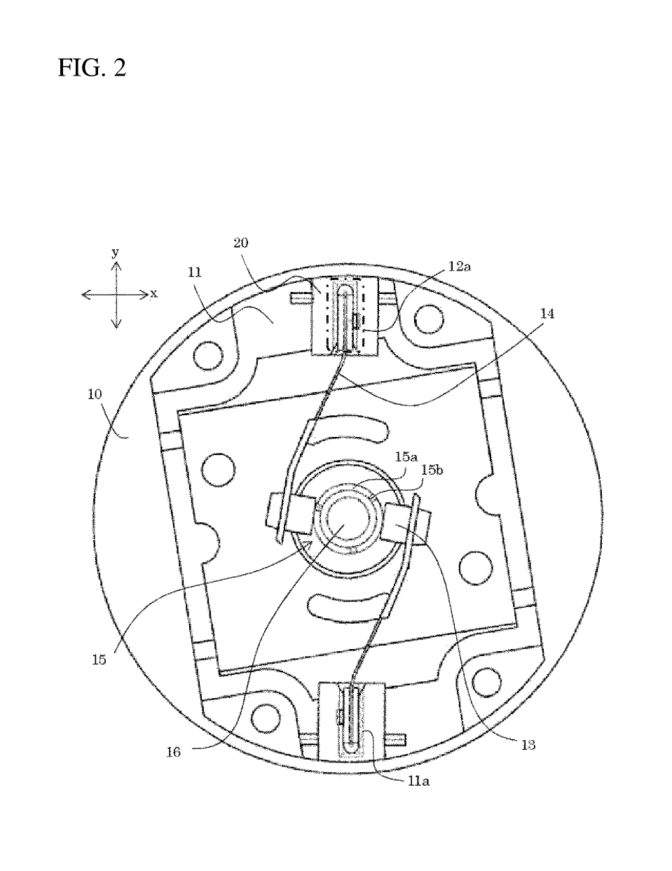

As illustrated in FIG. 1 and FIG. 2, the brushed motor 1 includes a housing 2 which has a bottom and is made from a metal material, such as cold-rolled steel sheet; a rotor 3 housed in the housing 2; brushes 13 contacting a commutator 15 which will be described later; a brush holder 11 which holds the brushes 13; and brush arms 14 biasing and supporting the commutator 15.

The housing 2 is formed in the shape of a cylinder with a bottom, and has one end which is opened and the other end which is closed. On the inner wall of the housing 2, an arc-shaped magnet 6 is disposed along the inner peripheral surface.

The rotor 3 includes a shaft 16; a rotor core 5; a coil 4; and a commutator 15.

The shaft 16 is a rotating shaft which supports the rotor 3. The shaft 16 is supported and fixed in a state of penetrating through the center of the rotor core 5, which includes a plurality of laminated steel sheets. The rotor core 5 has a groove in which the coil 4 is wound. With the brushes abutting on the commutator 15, electric current is supplied to the coil 4. The electric current flowing through the coil 4 produces a magnetic force which, through its interaction with the magnetic force from the magnet 6, turns the rotor 3.

The commutator 15 is fixed to the shaft 16, together with the rotor core 5. The commutator 15 provides metal contacts for supplying electric current to the coil 4 via the brushes 13 in contact with the commutator.

The commutator 15 has three commutator segments 15a which are fixed along the outer diameter of the shaft 16 at predetermined intervals 15b. As illustrated in FIG. 2, one of the pair of brushes 13 contacts one or two of the commutator segments, while the other brush contacts one or two of the commutator segments that are not in contact with the one brush. As the shaft 16 turns and the commutator 15 also rotates together, the commutator segments that contact the respective brushes are switched at a predetermined period, whereby commutation is performed for the brushed motor 1.

The brush arms 14 are formed as thin plates of flexible biasing members having a substantially rectangular shape. The brushes 13 are biased by the brush arms 14 in the x-direction while abutting on the commutator 15. Thus, the brush arms 14 also serve to electrically connect the commutator segments 15a and the brushes 13. The brushes 13 and the brush arms 14 are formed of electrically conductive members. For example, the brushes 13 are formed from graphite (carbon), and the brush arms 14 are formed from phosphor bronze.

In one end of the brush arms 14, the brushes 13 are held by being press-fit therein. The other end of the brush arms 14 is fixed to a terminal 12. The terminal 12 is held by the brush holder 11.

Specifically, the brushed motor 1 is internally provided with a brush mechanism. The brush mechanism includes the pair of brushes 13 in sliding contact with the commutator 15; the pair of brush arms 14 (flexible member) having the brushes 13 respectively held by being press-fit therein; and the terminal 12 with which one end of each of the brush arms 14 is linked. The terminal 12 is retained on the brush holder 11. The brush holder 11 is formed from a resin material, for example.

The terminal 12 includes a plate-like link member 12a which is bent in U-shape. The link member 12a has a first section 12e and a second section 12f opposing the first section 12e. The first section 12e and the second section 12f sandwich and support the brush arms 14 (flexible member) (a flexible member supporting step).

The brush holder 11 is provided with a terminal inserting portion 11a for inserting the terminal 12 with the link member 12a bent in U-shape. The terminal inserting portion 11a is formed in the shape of a recess. In the recessed section, the plate-like link member 12a bent in U-shaped is fitted and fixed.

The housing 2 has an opening portion in which an end-bell 10 formed from metal material is mounted. The end-bell 10 has the brush holder 11 fixed thereto. Via the brush holder 11, the brush mechanism is fixed. The end-bell 10 may be made from resin, in which case the end-bell 10 and the brush holder 11 may be integral.

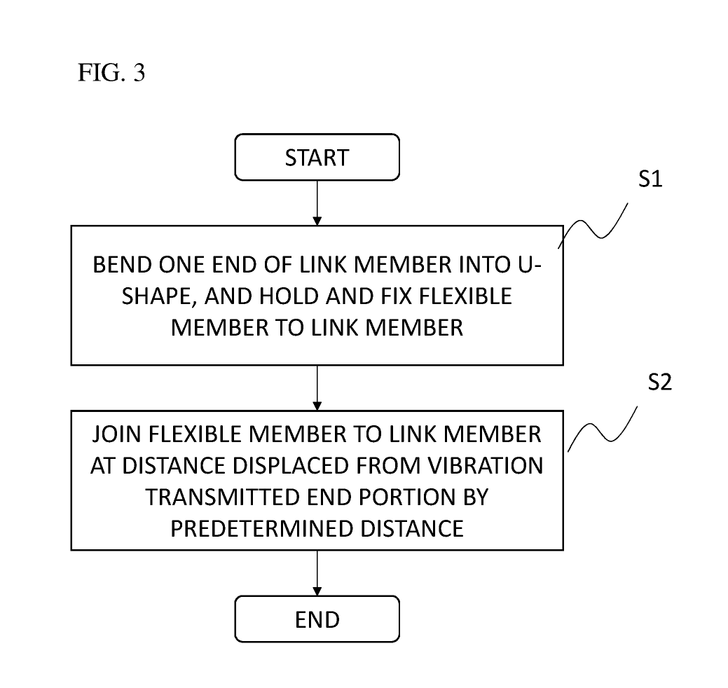

A method for linking the brush arms 14 to the link member 12a will be described with reference to FIG. 3. FIG. 3 is a flowchart for describing the procedure of the linking method according to an embodiment of the present invention.

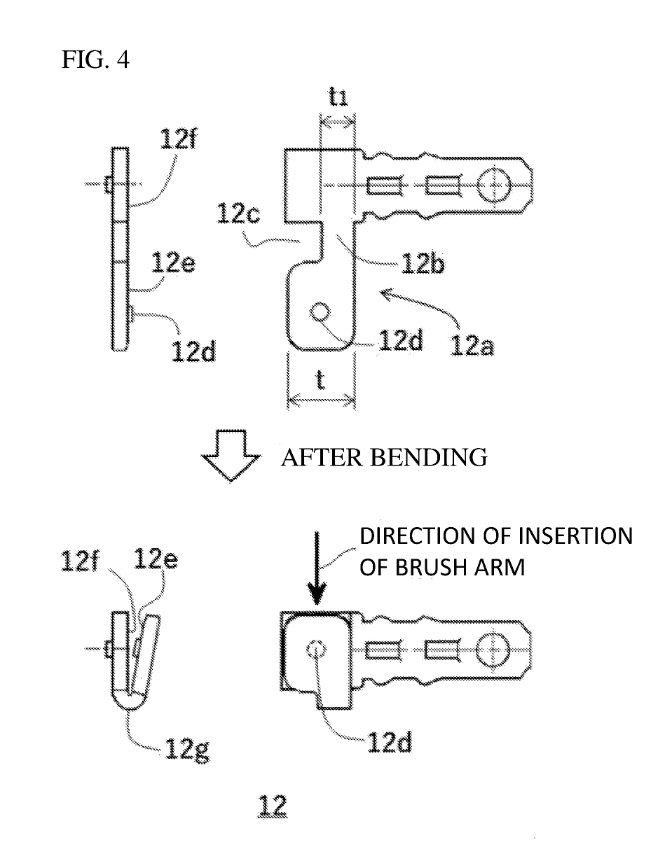

Referring to FIG. 3, first, the plate-like link member 12 is bent into U-shape in parallel or substantially in parallel with the longitudinal direction (refer to the y-direction in FIG. 2), forming a U-shape bent portion 12g (see FIG. 4) (step 1; hereafter, each step is designated by “S”). Then, one end of the brush arms 14 (flexible member) is linked with the link member 12a. More specifically, the substantially rectangular plate-like link member 12a is bent into U-shape in parallel or substantially in parallel with the longitudinal direction (refer to the y-direction in FIG. 2) so as to sandwich and hold one end of the brush arms 14 (flexible member), whereby the U-shape bent portion 12g (see FIG. 4) is formed in the link member 12a (flexible member supporting step).

FIG. 4 is a diagram corresponding to the portion of FIG. 2 enclosed by a dashed and single-dotted line, and shows plan views and side views illustrating the terminal before and after the link member 12a is bent into U-shape. The link member 12a is formed with a recessed cut-out portion 12c with a narrower plate width ti where the link member is bent into U-shape. The section with the narrower plate width ti constitutes a neck portion 12b which is bent into U-shape.

In this way, the link member 12a is made easier to be bent into U-shape, providing the effect of making the processing easier, eliminating variations in the accuracy of the bent position, and stabilizing product quality.

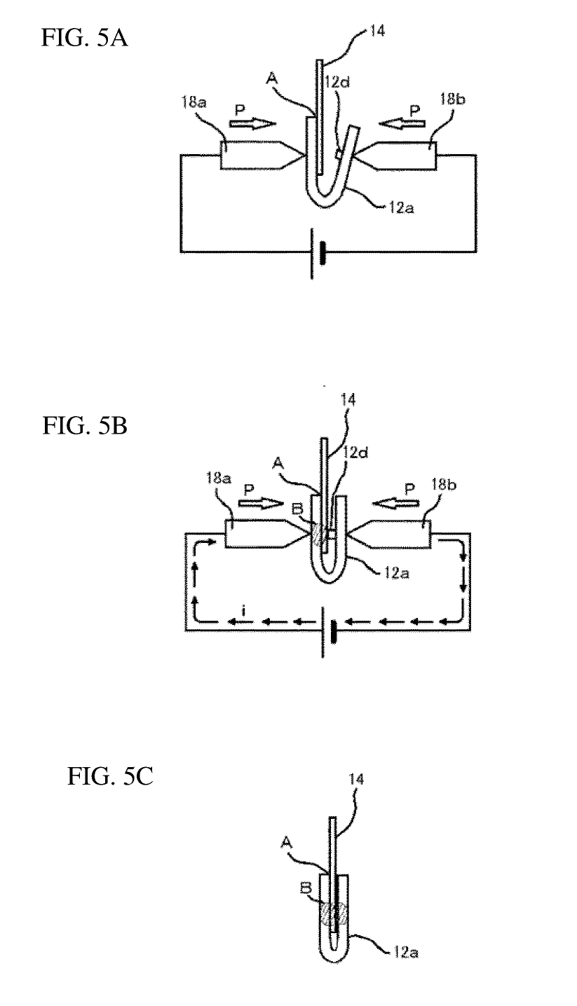

Referring back to FIG. 3, after the processing of S1, the linking process according to the embodiment of the present invention proceeds to a process of joining the brush arms 14 in a contact area in which the brush arms 14 (flexible member) contact the link member 12a and at a position spaced apart by a predetermined distance from a vibration transmitted end portion A (see FIGS. 5A, 5B) to which vibrations associated with high-speed, repetitive displacement (movement) in a predetermined direction due to rotation of the rotor (3) or external shaking are transmitted (S2, joining step). The joining process is performed by spot welding, for example. The link member 12a to which the brush arms 14 have been joined and which is bent into U-shape is fitted and fixed in the terminal inserting portion 11a of a fixed member 20 provided on an inner peripheral surface of the brush holder 11.

Further, according to the embodiment of the present invention, when the brush arms 14 are repeatedly subjected to loading due to a repetitive displacement (movement) in the predetermined direction, the vibrations are not readily transmitted because the link member 12a formed in a part of the terminal 12 and the brush arms 14 are joined so as to be spaced apart from the vibration transmitted end portion. Accordingly, the effect of better preventing the breaking of the joint of the brush arms 14 can be obtained.

In the joining process according to the embodiment of the present invention, at least one of the two surfaces of the first section 12e and the second section 12f opposed to each other by the bending in U-shape of the link member 12a may be joined with one surface of the brush arms 14.

Because it is only necessary to join one of the two surfaces of the first section 12e and the second section 12f, opposed to each other by the bending into U-shape of the link member 12a, and one surface of the brush arms 14, the effect of further reducing the number of assembly steps can be obtained.

The method for joining the brush arms 14 (flexible member) to the link member 12a will be concretely described with reference to FIGS. 5A-5C. FIGS. 5A-5C show plan views illustrating the joining process for describing the joining method according to the embodiment of the present invention.

In the method for joining the brush arms 14 according to the embodiment of the present invention, the link member 12 bent into U-shape such that the first section 12e and the second section 12f oppose each other is sandwiched from the outside by a pair of electrodes 18a, 18b. Then, pressure and electricity are applied to the first section 12e and the second section 12f of the link member 12 and the brush arms 14 at a predetermined timing.

Specifically, according to the predetermined timing, first, as illustrated in FIG. 5A, the pair of electrodes 18a, 18b is disposed so as to oppose each other at welding points on the link member 12 and the brush arm 14 contacting each other. Then, with the distal ends of the electrodes 18a, 18b being abutted at the position of a projecting portion 12d provided on the inner surface of the link member 12 bent into U-shape, the U-shape-bent sections of the link member 12 are pressurized in the direction of arrow P, causing the projecting portion 12d to contact the brush arm 14.

Referring to FIG. 5B, after the projecting portion 12d is contacted with the brush arm 14, electric current is supplied via the electrodes 18a, 18b (electric current i). While the electric current is being supplied, the first section 12e and the second section 12f at the brush arm 14 are pressed by the electrodes 18a, 18b in the direction of arrow P, thus pushing the projecting portion 12d onto the brush arm 14. In this way, the energized brush arm 14 and the projecting portion 12d, and part of the brush arm 14 are softened by resistive heating and become bound to each other (see part B in FIG. 5B), creating a pressure-welded spot due to the pressure from the electrodes 18a, 18b (see part B in FIG. 5C).

The “predetermined timing” herein refers to the timing of the procedure for joining the link member 12a and the brush arm 14. The predetermined timing, however, is not limited to the above. For example, with the electrodes 18a, 18b being supplied with electric current from the beginning, the first section 12e and the second section 12f of the link member 12a may be pressed in the direction of arrow P to perform the joining process for the link member 12a and the brush arm 14. Alternatively, the joining process may be performed by flowing electric current i intermittently and monitoring the state of joint between the link member 12a and the brush arm 14.

The projecting portion 12d is formed at the welding point at which the link member 12a and the brush arm 14 are joined. The projecting portion 12d is formed in a position which is in a contact area where the first and the second sections 12e, 12f contact the brush arm 14, and which is spaced apart from the vibration transmitted end portion A (see FIGS. 5A-5C), to which the vibrations of the brush arms 14 are transmitted, by a predetermined distance. The effect of the present invention is obtained as long as the vibration transmitted end portion A and the position of the welding point are not coincident and are distanced from each other even by a little. It is preferable, however, to perform the joining process for the link member 12a and the brush arm 14 by providing a certain distance from the vibration transmitted end portion A so that the vibrations are not transmitted.

Thus, according to the embodiment of the present invention, even when a repetitive displacement (movement) is caused in a predetermined direction due to the rotation of the rotor 3, and the brush arms 14 are repeatedly subjected to loading, the vibrations are not readily transmitted because the link member 12a and the brush arms 14 are joined so as to be spaced apart from the vibration transmitted end portion. Accordingly, the effect of better preventing the breaking of the joint of the brush arms 14 can be obtained.

In addition, as described above, the projecting portion 12d provided on the link member 12a serves to guide the flow of electricity to a desired location for joining, providing the effect enabling spot welding at a desired location.

Furthermore, the link member 12a includes the narrow neck portion 12b formed with a plate width ti smaller than the plate width t at the reference position for bending into U-shape. The narrower plate width ti creates a greater resistance to the passage of electric current i in the neck portion 12b. Accordingly, a flow of electric current i to undesired locations can be suppressed. In this way, it becomes possible to flow a large electric current to a desired position, providing the effect of decreasing weld time and increasing production efficiency.

The plate width ti of the neck portion 12b is ½ or less than the plate width t of the link member 12a, for example. However, the present invention is not limited to the above. In the present invention, the plate width ti of the neck portion 12b only needs to be smaller than the plate width t of the link member 12a.

While in the foregoing embodiment of the present invention, the projecting portion 12d is provided on the inner surface of the link member 12a bent into U-shape by way of example, the projecting portion 12d may not be provided. In this case, a cylindrical weld pin may be assembled onto the link member as a separate component instead of the projecting portion 12d, so that the flow of electric current i has a desired path, whereby the present invention may be achieved. In this way, the effect of simplifying the structure of the link member 12a and improving production efficiency can be obtained.

According to the above-described joining method according to the present invention, the bending of the link member 12a into U-shape is facilitated, whereby the assembly time can be further reduced and the bent position can be unified. Thus, there is also provided the effect of eliminating variations in the bent position depending on the assembly worker, and stabilizing product quality.

### Modification 1

The present invention is not limited to the foregoing modes of carrying out the invention, and may be variously modified within the scope of the claims. The technical means disclosed in different modes of carrying out the invention may be combined, as appropriate, and a resultant mode of carrying out the invention may also be included in the technical scope of the present invention. It is also possible to combine the technical means disclosed in each mode of carrying out the invention to provide new technical features.

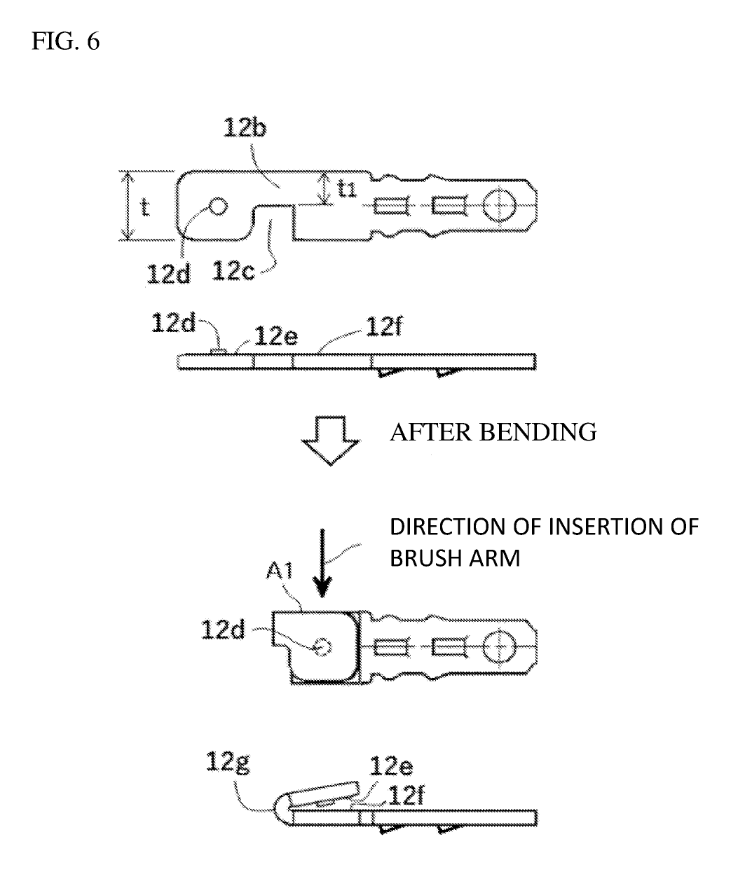

In the foregoing modes of carrying out the invention, the link member 12a of the terminal 12 may be configured such that the U-shaped bending portion is provided in a direction perpendicular to the brush arm 14 (flexible member), as illustrated in FIG. 6. Because the bending portion lies in the longitudinal direction of the terminal 12, the width of the terminal can be reduced, and the freedom of designing the brush holder is increased.

In this case, the vibration transmitted end portion where the vibrations of the brush arm due to the rotation of the rotor 3 or external shaking are transmitted to the link member 12 is the portion A1 where the brush arm 14 contacts, as illustrated in FIGS. 5A-5C.

### Modification 2

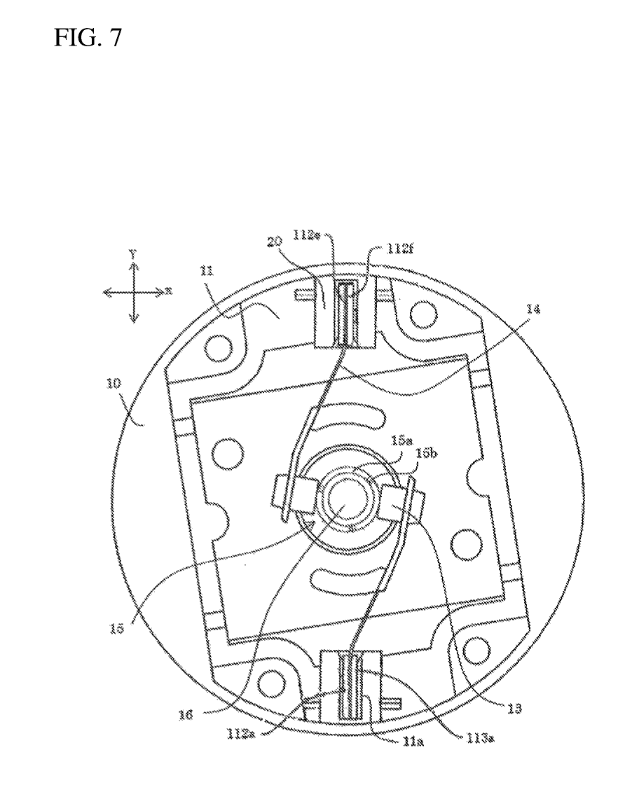

While the flexible member linking method according to a mode of carrying out the present invention has been described above where the link member is bent into U-shape and the flexible member is supported and fixed by being sandwiched, the present invention is not limited to the embodiment. For example, as illustrated in FIG. 7, it is also possible to implement the present invention in a configuration in which a pair of substantially rectangular plate members is used as terminal link members (a first section 112e of a first link member 112a and a second section 112f of a second link member 113a) to hold and fix the brush arms 14 by sandwiching the same from right and left.

In this case, spot welding is performed to ensure reliable joining of the first section 112e and the second section 112f opposing the first section 112e with both sides of the brush arms 14, so that the brush arms 14 can be held and fixed by the pair of the first and the second link members 112a, 113a (see FIG. 7, the first section 112e of the first link member 112a and the second section 112f of the second link member 113a).

In this case, instead of the flexible member supporting step according to the embodiment of the present invention, a flexible member supporting step may be provided to hold and fix the brush arm 14 by sandwiching the brush arm between the first section 112e and the second section 112f opposing the first section 112e of the pair of first and second link members 112a, 113a. The process of joining the first section 112e and the second section 112f and the brush arm 14 may be performed in the contact area where the first section 112e and the second section 112f contact the brush arm 14, at a position spaced apart by a predetermined distance from the vibration transmitted end portion to which the vibrations from the flexible member 14 are transmitted (joining step). The joining process in the joining step may be performed by pressing the first section 112e and the second section 112f with the pair of electrodes 18a, 18b until the projecting portion 12d provided on the second section 112f contacts the brush arm 14. The pair of first and second link members 112a, 113a holding and fixing the brush arm 14 is fitted and fixed in the terminal inserting portion 11a of the fixed member 20.

The projecting portion 12d is formed at the welding point where the first and the second link members 112a, 113a and the brush arm 14 are joined. The projecting portion 12d is formed in the contact area in which the first section 112e and the second section 112f contact the brush arm 14, at a position spaced apart by a predetermined distance from the vibration transmitted end portion where the vibrations of the brush arms 14 are transmitted. The effect of the present invention may be obtained as long as the vibration transmitted end portion and the position of the welding point are not coincident and are spaced apart from each other even by a little. It is preferable, however, to perform the joining process for the first section 112e and the second section 112f and the brush arm 14 by providing a certain distance from the vibration transmitted end portion so that the vibrations are not transmitted.

Thus, according to the embodiment according to the modification of the present invention, even when the brush arms 14 are repeatedly subjected to loading by being repeatedly displaced (moved) in a predetermined direction due to the rotation of the rotor 3, the vibrations are not readily transmitted because the pair of link members 112a, 113a and the brush arms 14 are joined so as to be spaced apart from the vibration transmitted end portion. Accordingly, the effect of being able to better prevent the breaking of the joint of the brush arms 14 is obtained.

In addition, as described above, the projecting portion 12d provided on the second section 112f of the second link member 113a makes it possible to guide the flow of electricity to a desired location for joining, providing the effect of being able to reliably perform spot welding at a desired location.

The flexible member as the object that is to be joined by the present invention only needs to be an elastic member that can be displaced in a predetermined direction, such as a stainless-steel, leaf spring-like thin plate material, for example. The flexible member applied in the present invention may be preferable for joining a thin plate material with a plate thickness of not more than 1 mm. It should be understood, however, that the present invention is also applicable with respect to thick plate material with a plate thickness in excess of 1 mm.

The flexible member may also include elastic wire material that can be displaced in a predetermined direction. Examples include piano wire, such as a coil spring, and spring steel material formed of oil tempered wire.

The flexible member linking method of the present invention is not limited to spot welding, and any method may be used as long as it is capable of reliably joining the link member and the brush arm (flexible member). For example, the present invention may be implemented by joining the link member and the flexible member by diffusion bonding, thermal pressure bonding, friction pressure-welding, brazing, or adhesion.

While a motor end-bell assembly has been described by way of example to which the linking method according to the embodiment of the present invention is applied, this is not a limitation. The present invention is also applicable in a configuration in which a flexible member is elastically deformed due to a reciprocal movement in an oscillating direction.

The device to which the linking method used in the present invention is applied is not limited to that of the above example or the modifications. For example, the linking method may be applied to a linear actuator including a fixed member with a bottom which is made from a metal material, such as stainless-steel, and a movable member which executes a reciprocal movement in an oscillating direction with respect to the fixed member.

In this case, on the bottom surface of the fixed member, a coil assembly including a stator core, an insulator, and a coil is supported and fixed. The insulator is formed from an insulating material, disposed between the stator core and the coil wound on the stator core, and installed to cover the stator core.

The movable member is linked with the fixed member via the flexible member. As the coil is energized, the magnet receives force in accordance with a periodic change of a magnetic field created by the supply of electric current, and the movable member executes a reciprocal movement in the oscillating direction. As the flexible member is a plate member, the oscillating direction is in the plate thickness direction (the widthwise direction of the cross section of the plate material).

The magnet is fitted with a back yoke made from magnetic material to form a magnetic path. The back yoke is disposed on the back surface of the magnet. If a magnetic path that satisfies required performance can be formed with the stator core and the magnet, the back yoke may be omitted.

The flexible member includes a substantially rectangular plate-like member, with one end held and fixed to the fixed member, the other end being linked with the outer surface of the movable member. The flexible member is linked with the movable member so as to be displaced in the oscillating direction. As the movable member executes a high-speed reciprocal movement in the oscillating direction, the flexible member is elastically deformed in the oscillating direction. The movable member is supported on the fixed member in a reciprocally moveable manner. Accordingly, the present invention is also applicable with respect to a flexible member linking method where the movable member is linked with the fixed member via the flexible member, and the movable member executes a reciprocal movement in the fixed member.

The plate-like link member holding and fixing the one end of the flexible member is disposed, e.g., on the outer surface of the movable member and adjacent to the direction in which the flexible member executes the reciprocal movement in the oscillating direction, where the link member is bent in parallel or substantially in parallel with the longitudinal direction into U-shape, forming a U-shape bent portion. The movable member is linked with the fixed member via the flexible member. For this purpose, first, the substantially rectangular plate-like link member, which is disposed adjacent to the direction in which the movable member is displaced in the attitude in which the movable member is installed, i.e., in the direction in which the reciprocal movement is executed in the oscillating direction, is bent into U-shape in parallel or substantially in parallel with the longitudinal direction in such a way that one end of the flexible member is sandwiched, thus forming the U-shape bent portion. The subsequent flexible member holding step and joining process step of the flexible member linking method are similar to those of the foregoing embodiment.

In this case, the movable member and the link member may be integrally formed or configured as separate members when the present invention is implemented. When the movable member and the link member are configured as separate members, the movable member and the link member may be joined by spot welding, diffusion bonding, thermal pressure bonding, friction pressure bonding, brazing, or adhesion, for example. Alternatively, the fixed member may also be provided with a plate-like link member, and the fixed member may be linked with the other end portion of the flexible member.

In the present modification, too, it is also possible to hold the flexible member in such a way that a pair of first and second link members is sandwiched by the link member.

Because the flexible member is sandwiched and fixed by the link member in the present invention, even when the flexible member is fixed by crimping, the punch would be received by the link member, sparing the crimped portion from excessive loading. Accordingly, a satisfactory link can be achieved by crimping. In this case, for example, the flexible member may be provided with a through-hole, one of the bent portions of the link member may be provided with a projection and the other with a through-hole, and the projection may be passed through the two through-holes and then crimped and fixed.

The device to which the linking method used in the present invention is applied may include electric shavers, electric toothbrushes, cellular phones, and dampers (damping device) in which a leaf spring is used as a flexible member. The linking method may also be applied to vibrating devices or oscillating devices generally in which a movable member that executes a reciprocal movement in a linear direction is fixed with respect to a fixed member using a coil spring so as to achieve reciprocal movement.

What is claimed is:

1. A method for linking a flexible member that is displaced in a predetermined direction, and a fixed member linked with the flexible member, the flexible member linking method comprising:
a flexible member supporting step of sandwiching and supporting the flexible member by a first section of a plate-like link member fixed and held to the fixed member, and a second section of the link member opposed to the first section; and
a joining step of joining at least one of the first section and the second section and the flexible member in a contact area in which the first and the second sections contact the flexible member, at a position spaced apart by a predetermined distance from a vibration transmitted end portion where vibrations from the flexible member are transmitted.

2. The flexible member linking method according to claim 1, wherein
the link member includes a U-shape bent portion bent into U-shape,
the first and the second sections are configured as two opposing surfaces of the U-shape bent portion,
the flexible member supporting step includes sandwiching and supporting the flexible member by the first and the second sections, and
the joining step includes joining at least one of the first section and the second section of the link member and the flexible member.

3. The flexible member linking method according to claim 2, wherein the second section includes a projecting portion, and the U-shape bent portion is configured to be bent into U-shape until the projecting portion contacts the flexible member.

4. The flexible member linking method according to claim 2, wherein
the link member includes a neck portion with a reduced width in a widthwise direction, and
the U-shape bent portion is configured to bend the link member into U-shape with reference to the neck portion.

5. The flexible member linking method according to claim 3, wherein
the link member includes a neck portion with a reduced width in a widthwise direction, and
the U-shape bent portion is configured to bend the link member into U-shape with reference to the neck portion.

6. The flexible member linking method according to claim 1, wherein
the link member comprises a first link member and a second link member,
the flexible member supporting step includes a step of sandwiching and supporting the flexible member by the first section of the first link member and the second section of the second link member opposing the first section, and
the flexible member linking method includes a joining step of joining the first and the second sections and the flexible member in a contact area in which the first and the second sections contact the flexible member, at a position spaced apart by a predetermined distance from a vibration transmitted end portion where vibrations from the flexible member are transmitted.

7. The flexible member linking method according to claim 6, wherein
the second section is provided with a projecting portion, and
the flexible member supporting step includes supporting the flexible member by the first and the second sections of the link member in such a way that the projecting portion contacts the flexible member.
